(19) United States
(12) Patent Application Publication
(10) Pub. No.: US 2009/0128783 A1
(43) Pub. Date: May 21, 2009

(54) Ocular-protection projector device

(76) Inventors: Yueh-Hong Shih, Hsinchu City (TW); Hei-Tai Hong, Hsinchu City (TW); Chun-Yuan Cheng, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/984,237

(22) Filed: Nov. 15, 2007

(51) Int. Cl. G03B 21/26

(52) U.S. Cl. 353/28

(57) ABSTRACT

The present invention discloses an ocular-protection projector device, wherein the projector is additionally equipped with an image-capture unit. When the projector projects information onto a screen, the image-capture unit captures the human-shape image of a user. An image-processing unit, which is arranged inside the projector or an external electronic device, receives the human-shape image, creates a human-shape black mask, and outputs the human-shape black mask via the projector onto an area of the screen corresponding to the user's position. Thereby, the present invention can effectively protect the user's eyes from the harm of intense light.

### BACKGROUND OF THE INVENTION

1. Field of the Invention

The present invention relates to an improved projector device, particularly to an ocular-protection projector device.

2. Description of the Related Art

Nowadays, multimedia briefing implemented with a projector has been very popular in the achievement report, seminars, thesis presentation, etc., in the academic field, and the project proposal, business achievement report, etc., in the business and industry fields.

A speaker will prepare digital pictures beforehand, and the digital pictures will be sequentially projected onto a screen with a projector during his speech. Generally, the speaker will stand before the audience and face the projector. In such a case, the intense light from the projector will dazzle the speaker or even momentarily darken his eyes. Long-time direct exposure to the intense light of the projector may cause an eternal harm on the eyes. Therefore, a preventive solution for such a problem is desired.

Accordingly, the present invention proposes an ocular-protection projector device to prevent a speaker from being dazzled by the intense light of a projector in a briefing session.

### SUMMARY OF THE INVENTION

The primary objective of the present invention is to provide an ocular-protection projector device, wherein a black mask is output to a corresponding position on the screen to prevent dazzling light from directly entering human eyes.

Another objective of the present invention is to provide an ocular-protection projector device, which can provide a comfort environment for a briefing session.

To achieve the abovementioned objectives, the present invention proposes an ocular-protection projector device, which comprises: a projector projecting information onto a screen, an image-capture unit capturing images of at least one user; and an image-processing unit receiving images from the image-capture unit, processing the images to create a black mask, and outputting the black mask to the screen according to the current position of the user.

Below, the embodiments of the present invention will be described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing the architecture of the present invention; and

FIG. 2 is a diagram schematically showing a human-shape black mask according to the present invention.

### DETAILED DESCRIPTION OF THE INVENTION

The ocular-protection projector device proposed by the present invention can create and output a black mask onto the screen according to the position of the user to prevent intense light from dazzling the user. Thus, the user's eyes are protected.

There are various types of projectors, such as front projectors and ceiling front projectors. However, the present invention applies to all types of projectors. Below, the front projector is used in the exemplification of the present invention.

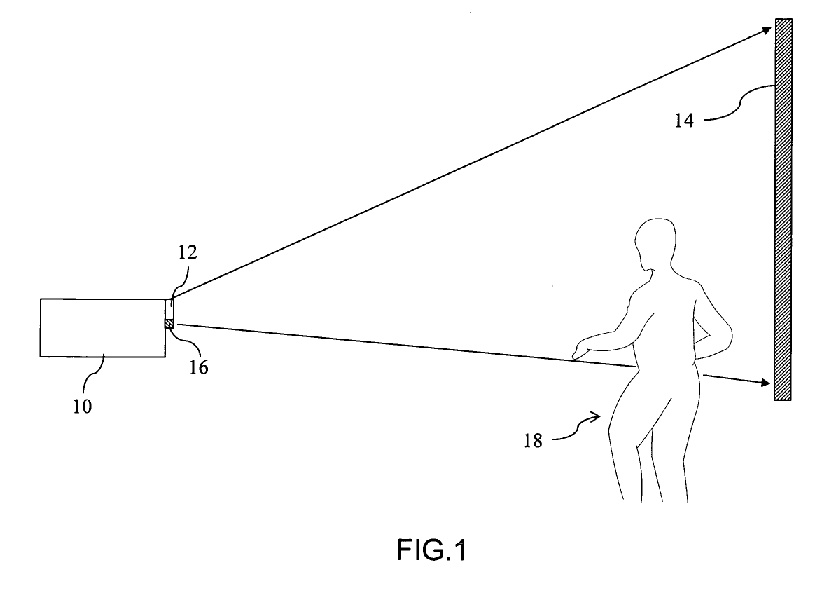

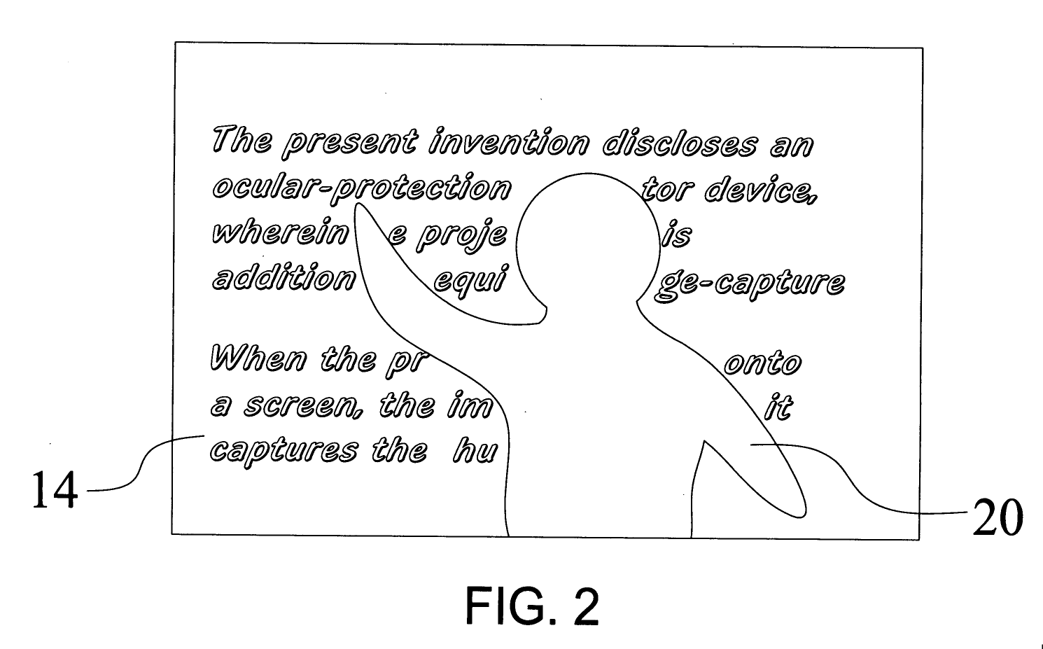

Refer to FIG. 1. The ocular-protection projector device of the present invention comprises: a projector 10 and an image-capture unit 16. The projector 10 has a projector lens 12 and circuits (not shown in the drawings), including CPU. The projector 10 can project information onto a screen 14. The image-capture unit 16 can be realized with a CCD (Charge-Coupled Device) or a CMOS (Complementary Metal Oxide Semiconductor) sensor element. The image-capture unit 16 is arranged on the surface of the projector 10 and detects human faces to determine the position of a user 18. Then, the image-capture unit 16 captures the shape of the user 18 and sends the shape to an image-processing unit (not shown in the drawings) inside the CPU. Refer to FIG. 2. The image-processing unit receives the shape and works out a human-shape black mask 20. Then, via the projector 10, the image-processing unit outputs the human-shape black mask 20 onto an area of the screen 14 corresponding to the position of the user 18.

The human-face detection technology is first finding out a reference point and then using a displacement vector to detect the existence of the user. If the illumination is insufficient, a complementary light source, such as an infrared light source, is used to benefit image capture. The complementary light source may be arranged on the projector or elsewhere.

Refer to FIG. 1 and FIG. 2. In the present invention, the human-shape black mask 20 is output onto an area of the screen 14 corresponding to the position of the user 18. When the user 18 confronts the dazzling light from the projector lens 12, the human-shape black mask 20 always appears in the dazzling light to protect the user's eyes from the intense light and provide the user 18 with a comfortable briefing environment.

The abovementioned black mask is exemplified with but not limited to a human-shape black mask. Any arbitrary-shape black mask may also work if it can protect the user's eyes. In addition to being built in the projector, the abovementioned image-processing unit, which creates the black mask, may also be arranged in an external electronic device. The external electronic device may be a personal computer, a notebook computer, or a PDA (Personal Digital Assistant).

The embodiments described above are to exemplify the characteristics and technical contents to enable the persons skilled in the art to understand, make, and use the present invention. However, it is not to limit the scope of the present invention. Any equivalent modification or variation according to the spirit of the present invention is to be also included within the scope of the present invention.

What is claimed is:

1. An ocular-protection projector device comprising:
a projector projecting information onto a screen;
at least one image-capture unit arranged in said projector and capturing at least one user's image; and
an image-processing unit receiving said user's image, creating a black mask and outputting said black mask via said projector onto an area of said screen corresponding to a user's position.

2. The ocular-protection projector device according to claim 1, wherein said image-processing unit is arranged inside said projector; said projector further comprises a central processing unit, and said image-processing unit is built in said central processing unit.

3. The ocular-protection projector device according to claim 1, wherein said image-processing unit is arranged in an external electronic device and used to create said black mask.

4. The ocular-protection projector device according to claim 3, wherein said external electronic device is a personal computer, a notebook computer, or a PDA (Personal Digital Assistant).

5. The ocular-protection projector device according to claim 1, wherein said image-capture unit is a CCD (Charge-Coupled Device) or a CMOS (Complementary Metal Oxide Semiconductor) sensor element.

6. The ocular-protection projector device according to claim 1, wherein said image-capture unit acquires said user's image via detecting human faces.

7. The ocular-protection projector device according to claim 6, wherein said detecting human faces is first finding out a reference point and then using a displacement vector to detect the existence of a user.

8. The ocular-protection projector device according to claim 1, wherein said projector is a front projector or a ceiling front projector.

9. The ocular-protection projector device according to claim 1 further comprising a complementary light source providing illumination for said image-capture unit.

10. The ocular-protection projector device according to claim 9, wherein said complementary light source is an infrared light source.
